(19) United States
(12) Patent Application Publication
(10) Pub. No.: US 2010/0122163 A1
(43) Pub. Date: May 13, 2010

(54) SYSTEM AND METHOD FOR VIDEO TRAINING AND INFORMATION ON TOOLS USED IN THE VIDEO AND WEB SITE FOR EXCHANGE OF INFORMATION

(76) Inventors: Daniel Goldberg, Boulder, CO (US); Richard Rosenfield, Portland, OR (US)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/617,446

(22) Filed: Nov. 12, 2009

Related U.S. Application Data
(60) Provisional application No. 61/113,818, filed on Nov. 12, 2008.

(51) Int. Cl. G06F 3/01

(52) U.S. Cl. 715/705

(57) ABSTRACT

An interactive web site for use by a community of users includes multimedia information for education and use by the users. The multimedia information includes video information that demonstrates procedures of interest to the community. Tags are provided to the video identifying products and tools used in the video. Links are presented on the web site linking to additional information on the products and tools. Links are also provided that automatically schedule telephone conferences or other communications between the users and vendors of the products or services tagged in the videos.

### CROSS-REFERENCE TO RELATED APPLICATION

This application claims the benefit of U.S. Provisional Patent Application Ser. No. 61/113,818, filed Nov. 12, 2008, which is incorporated by reference herein.

### BACKGROUND OF THE INVENTION

1. Field of the Invention

The present invention relates generally to method and apparatus for exchanging information between members of a profession and for setting up contacts between users of a product and providers of the product.

2. Description of the Related Art

It is important that doctors and other medical professionals be provided with up to date information on procedures and products in their field. Doctors and other medical professionals often have busy and unpredictable schedules that prevent them from traveling to medical seminars to learn new techniques and meeting other professionals in their field.

Providers of medical instruments and products may be unable to reach the medical professionals in the relevant field due to unavailability of the medical professional or, due to screening efforts of the medical professional's staff, who may be inundated with requests from medical and pharmaceutical suppliers.

### SUMMARY OF THE INVENTION

The present invention provides a communication channel via a web site or other network connected interface that enables members of a community or profession to share information including multimedia information relevant to the community or profession.

The present invention also provides a web site or other network connected interface that operates to link information and training on new procedures and processes to information on devices and materials used in performing the processes and procedures, and further to link the viewer of the information on the procedures and processes to providers of the devices and materials used in the procedures and processes. Further, the present method and apparatus automatically sets up or schedules communications between the user and the device or materials provider.

In one example, the present method and apparatus provides a web site for use by surgeons where a surgeon may view video files of surgical procedures and learn of procedures and of surgical tools used for performing the procedures. The web site includes information on the tools used in the surgery and links to further information on the surgical tools. In addition, the links permit the medical professional to automatically schedule telephone calls between the tool provider and the medical professional. As a further development, information on the scheduled telephone call is automatically forwarded to the office manager or other staff of the medical professional.

Thus, in tool-centric practices such as surgery, the surgeon is kept up to date with the latest procedures and provided with direct contact to the provider of the surgical tools used to perform those procedures.

As a further aspect, the web site provides communications between members of the community, such as by providing communications channels between the surgeons or other medical professionals, such as via instant emailing, texting, video chat, text chat, URL linking, blogs, bulletin boards or other communications means. The web site provides a repository of information, including text, graphs, video information, interactive images and text relating to the community. The user may comment on the information available at the web site or upload their own images, text and video, thereby sharing their experience with the community.

Another feature of some embodiments of the invention provides television or other multimedia communications between users which comply with patient privacy standards, such as HIPAA standards.

In addition to the public archives provided at the web site, the site also provides a private archive for individuals, user groups, organizations or other entities at which information for only selected users may be provided. An example of such private archive information is an academic group operating as an information repository and exchange for the group.

A further aspect of the web site is an industry corner where vendors and others in the industry utilize contacts and provide information to users. The vendors may include vendors that supply the surgical tools used in the video information provided at the site, for example.

The present method and system provides a web-based experience which provides a virtual bridge between members of a community who share a professional, creative or personal focus. An objective is to facilitate direct and effortless of interactivity for this connectivity, and to help foster enhanced relationships, information sharing, and growth of the individual and the overall community through this effort.

The means by which this and other objectives are provided is by establishing: bridges between users to content of fellow users; bridges between users to users (to enhance old relationships or form new ones); bridges between users to industry vendors within this community, in a very easy manner, in order to enhance the user's awareness of industry vendors offerings important to the community, ultimately to enhance the capabilities or talents of the users, through their exploiting these key products or services their work and success depend upon.

The outcome of the system is to advance personal, professional or creative practices for the each community member individually and for the group as a whole (i.e., the surgical medical field's ability to provide the best patient care).

The present method and system offers the facility to easily connect users of different groups or diverse geographical regions within the same community (such as professional, amateur and public) together, as well as to connect the wide range of users to the industry vendors that service this community within a creative method driven by the user's own interest in seeking out such items. The technology takes advantage of the time zone and geographically independent nature of the Internet in order to connect people across the globe and at their own convenience. The technology also exploits user-generated content sharing itself as a mechanism for the connectivity, at the same time deepening the knowledge and subsequent practical capabilities of the community through the inventions ability to facilitate education through content and community collaboration.

Thus, a cornerstone of the method and system provides connectivity, collaboration, sharing and education via its unique presentation and assembly of features.

A focus of the system and method is on community types like the medical community as an example, where the surgeons who constitute that user base seek quick and friendly access to community information, media (i.e., videos of surgical procedures) and each other in a quick web experience.

Moreover, the communities the present invention are focused upon are those that profoundly need to utilize their industry's highly innovative technologies for their work or personal growth (such as the surgeon's core demand for better and more productive surgical operating devices). In an industry such as minimally invasive or video assisted surgery (e.g., gynecological laparoscopic surgery), access to watching peers' video recordings of the same work the surgeon user herself/himself performs radically enhances that surgeon's ability to provide care.

Moreover, the surgeon's work is at the limit of the technologies they use. Thus, while watching a video of a surgery the surgeon seeks to learn from, the surgeon also observes the exact tools (the vendor products) that make that surgery a success. The surgical tools or other products in that surgeon's hands powerfully define and innovate their capabilities to perform the work the surgeons do from day to day.

The present method and system follows up on that moment: the web interface provides the tool-centric community user (such as a surgeon) with a direct representation of the very tools used in the video the surgeon is watching and which let that surgery happen, then let the surgeon readily click on those tool names and enter into a quick and easy rich-media experience of what those tools are: to see videos, data specifications and marketing information from the vendor in a vendor hosted realm within their community. At the same moment, the surgeon makes a one-click gesture to hold a video chat with that vendor, email that vendor or have that vendor call the surgeon's office immediately for a follow up so the surgeon can acquire these best tools with ease. This all occurs through the efficient and organic process of the surgeon's brief experience online wanting to learn about a surgery, watching a video, finding products responsible for that surgery and now reaching out to the industry vendors able to help the surgeon reach the goal of attaining those products or services in their mission to provide best patient care and serve the medical community.

In an industry or profession like media-assisted surgery, video recorded during a surgical procedure can be shared afterward with others as a teaching tool. Other surgeon users of the present method and system gain from viewing videos by the surgeon's peers. Similarly, artists or other group types that rely on specific technologies for their work can benefit from use of the present system and method.

A surgeon is very much tethered to the technologies and tools they use. They need a place to learn of the latest tools. A surgeon also benefits from watching peers use these same tools and technologies. Social network sites alone do not provide with an integrated synthesis of industry and user base which is the core of the present method and system and with the ease and simplicity in doing that which the present system and method provides through the technology mechanisms that are integrated with one another (which are discussed below).

The present method and system addresses the need for a time-sensitive online experience, with quantities of desired information being made available with the few clicks, easy effort and in an organic user driven method, and to communities of professionals who do not seek to spend a lot of time on the web. Thus, its interface is simplified, pleasant and inviting and its functionality very easy to understand and use.

The busy schedule of the surgeon, who needs to be aware of the latest tools available for their work often does not have the time to search for and learn of all of these new tools and updates of product offerings as they are being updated. The surgeon's ability to provide safe, quick and quality patient care is based on the complex and frequently advancing devices the vendors create (such as hi-def video capturing technology, virtual scalpels, suctions) surgery devices. The demands on the surgeon's time prevent them from traveling to trade shows around the world or even to regional conferences.

Furthermore, sales teams of vendors of surgical tools aim to reach the global community of users of their products but cannot possibly disseminate key updated product or services information to this base in all regions simultaneously, especially since the users (the busy surgeon) does not have the abundance of time or inclination to search the web across multiple vendors sites for their latest offerings.

Lastly, the vendor players in the industry constantly change through mergers and acquisitions and become more and more of moving targets, which make it harder for a surgeon to stay up to date with their status or even website location.

The surgeon does not have the kind of time to search the web endlessly to understand and reach out to the myriad of vendors that service their field. The present method and system captures all industry vendor partners' information to a given community and seamlessly provides a connectivity between those whose daily work/life require their products and services, with instant emailing, texting, video chat and URL linking easily from within the system which connects users to users and users to information.

The medical community's problem is resolved with a single web destination that serves the community, provides the community with interactive information, videos, a network that grows and provides increasing benefit to the community, and the same easy interactivity and simple least-clicks ability to reach out to all industry vendor information. The medical community is not the only field that can benefit from this easy to use, media-centric and vendor to user sharing functionality. The consolidated community created with the present web technology becomes tightly connected with a simple, easy to use web site utilizing least mouse clicks linking in order to share, collaborate and interact users with each other using video chat, text chat, and email.

For the bridge to the entire scope of industry vendors and their products or services in a given community, the present method and system provides the following:

The connection activity in the system is centered around a public archive of rich media content that different users in the community create and share. Each uploading user explains the products or services that helped make their content come into existence by tagging each uploaded content with the names of vendors providing the associated products or services.

As users appreciate the content they view, they are presented with the names of the products or services connected with that piece of content, and when clicking on these names they can instantly connect with a private world inside the web experience to learn more about these particular products or services that can enhance their own professional, creative or personal existence. From within this vendor hosted private world the user is presented with images, rich media and greater details of various offerings and events of the vendor, and through single clicking on these details the user is effortlessly connected to the specific URL locations (web pages) of the vendor's private website itself. The user can also simply click a “have vendor contact me” button and go right to bed, knowing that tomorrow his/her office will be contacted by the vendor at a time, phone number or email address he/she had told our system to precisely pass over to the vendor with such a request for contact.

In the present invention is provided a private archive, a web-based home for all users to store, search and retrieve content that they require and which they would like maintained offsite from their home or office without any IT (Information Technology) management cares of their own; these assets can also be shared in the public archive for other users to benefit from or specifically hidden away from the public areas and made accessible only to the content owner for private viewing and global access from anywhere a connection to the internet is available.

### BRIEF DESCRIPTION OF THE DRAWINGS

FIG. 1 is a screen shot of an embodiment of a web interface according to the principles of the present invention;

FIG. 2 is a flow chart showing an embodiment of a method according to the invention;

FIG. 3 is a functional block diagram of a hosting configuration for the system according to the present invention;

FIG. 4 is a schematic diagram of a communication channel of the present for carrying out the method of the invention; and

FIGS. 5a-5f are screen shots of a user interface according to the present invention.

### DETAILED DESCRIPTION OF THE PREFERRED EMBODIMENTS

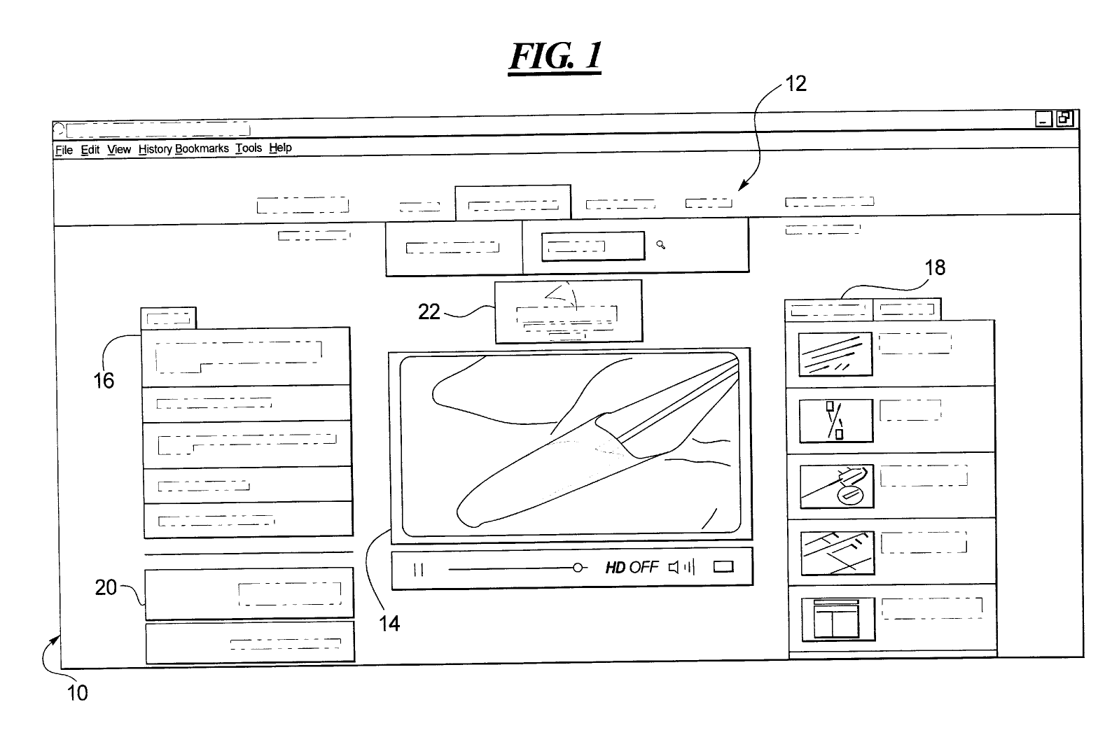

The present invention includes a user interface 10, as shown in FIG. 1, that is displayed on a computer system and that provides the user with information relating to a profession or community of users and that connects users to vendors, industry or other users via the information provided through the user interface. The user interface 10 includes menu options 12 shown as tabs, a central video display screen 14, a messages section 16, a featured products portion 18, and commands 20 to request one-on-one contact with the vendor of a selected tool or product. In further detail, the tabs 12 include tabs for search, industry corner, collaborate, connect and manage account, all of which will be described in more detail below. The user interface 10 is currently at the industry corner tab, which displays the video screen 14. The video screen 14 includes controls common to on-line video players, including play and pause buttons, an audio volume control, a full screen command, a progress bar, an indicator of the resolution of the video signal, and an indicator (shown in the current view) that the video file is currently downloading from a server. The example video shown in FIG. 1 is a video of a laparoscopic surgical procedure demonstrating a surgical technique that may be unknown to other surgeons.

The products portion 18 shows surgical tools or materials that are being used in the video. Similar tools or tools for similar procedures may also be shown. In the example, the products portion 18 includes a photograph or image of the tool and a description or tool name. For example, the first listed tool is a Falope Ring Band. The products are listed under a tab entitled, Featured Products. Another tab is provided, entitled Hot New Stuff, that introduces new tools or techniques to the user.

The messages portion 16 of the user interface 10 includes information and news relating to the products and procedures including news alerts, educational material, brochures, product overview and information on changes in vendors of the products. The vendor of the demonstrated product is shown in a label 22 above the video screen 14.

The contact request portion 20 includes two command buttons, a first requesting by the user to start a chat with the vendor of the product. The button also indicates that the vendor is currently on line, and thus available for the chat session. The second command is a request by the user to have a representative of the vendor contact the user's office. Selection of this command opens a request that the user provide a preferred time for the contact, which will be via telephone by the vendor's representative to the user's office.

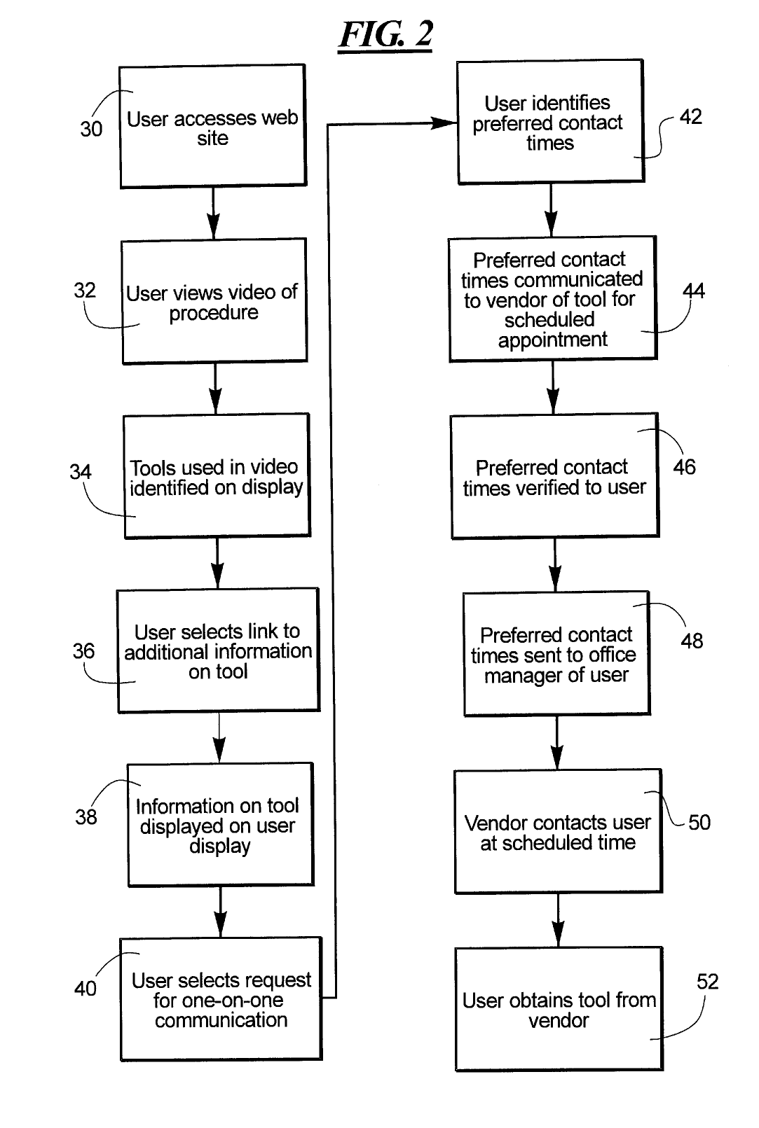

Turning to FIG. 2, the method of the present invention includes in one example the step 30 of the user accessing the web site according to the invention. The user in the example is a surgeon seeking information on surgical procedures and tools. However, the present method may be applied to any community of users, such as skilled craftsman, hobbyists, mechanics, collectors, or others sharing a common interest and needing a channel to contact vendors of related tools, materials, supplies or other items. The user accesses the web site using a computer which may be an office computer, home computer, mobile computer, workstation, kiosk, portable electronic device, smart phone, PDA or other network connected computer device capable of displaying a user interface.

In the example, the user has selected a video to view on the user interface, as shown in step 32. The video for example is a laparoscopic surgical procedure about which the user wishes to learn. The video is played on the display of the user computer and can be replayed, stopped, started as desired by the user. In step 34, the user interface identifies tools that are used in the video. The tools are listed, and preferably described, on the display adjacent to the video. It is also contemplated that the tools may be identified before and/or after the playing of the video. The tools have been tagged by the provider of the video to ensure that the proper tool is identified in step 34. The tags may appear in the video frame as well.

Here, the user is interested in one of the tools shown in the video and selects, at step 36, the link identifying the tool of interest. In response, step 38 displays additional information on the tool on the user's display. After learning more about the tool, the user selects a button requesting a one-on-one communication from the vendor's representative, at step 40. The user prefers to be contacted later by the vendor and so has selected the request for a contact at the user's office. The user inputs one or more preferred contact times at step 42. In step 44, the preferred contact times are transmitted to the vendor so that a telephone conference can be scheduled. This may include automated entry of the time on the calendaring software of the vendor's representative.

In step 46, the contact time is verified to the user, which may be by a confirming email or by an automated entry into the user's calendar program. The user in this example is a doctor based in an office where office staff tracks appointments by the doctor. The preferred contact times are sent to the office manager of the user at step 48. In this case, the one-on-one communication is carried out by a telephone call from the vendor's representative to the user, at step 50. The user is interested in the tool offered by the representative and at step 52 obtains the tool from the representative.

The computer system on which the user interface is displayed communicates through a network connection, such as via the Internet or other network, with server computers on which the information and operating programs are stored on tangible computer readable media. The computer system on which the user interface is displayed also includes a tangible computer readable media on which data and programs of the invention are stored. The user computer system may be located in the same area, region or country as the server computer with which it is communicating or may be in a different area, region or country. The network connection of one embodiment includes connections via the world wide web, or the web, as well as other communication protocols such as Internet relay chat or other chat protocols and may include other networking communication protocols and functionality.

The user interface of one embodiment is displayed on a display panel of a user computer by a browser program. The browser program may be stored on the local tangible computer readable media of the user computer or may be stored on a remote computer device including on a distributed storage system. The user interface need not be provided through a browser but may be provided through another program on the user computer. Content that the user has may be uploaded by the user to the servers, such content may be stored locally on the user computer storage media or may be on a network to which the user computer is connected.

The user computer may be any of a variety of different computer types, including desktop or laptop computer, a smart phone, PDA (personal data assistant), portable telephone device, tablet computer, workstation, kiosk, or other type of computer device. The computer device may be associated with another device, system or functionality, such as a television system or other media device.

An aspect of the invention is to automatically schedule a telephone conversation, visit, chat or other one-on-one communication between a user and a vendor of a product in which the user has expressed an interest. The scheduling of the one-on-one communication is performed in one embodiment by transmitting automatically generated emails that are sent following the request for communication by the user. In one example, the vendor of the product receives an email identifying the user, identifying a preferred contact time and date and a telephone number and/or email address at which the vendor may contact the user. It is also possible that the user may identify another person to be contacted by the vendor, such as a staff member at the user's office. Further, the email to the vendor may provide information on the user's practice area, street address of the user's office, and possibly other information. The email to the vendor corresponds to step 44 in FIG. 2. The email may be entered by the vendor's representative into a scheduling program or may trigger an automatic entry of the time and date into the representatives schedule or calendar.

An email is sent to the user confirming the telephone call or other one-on-one communication, including a confirmation of the time and date as well as the contact person and contact telephone number. The confirming email corresponds to step 46 in FIG. 2. In the example, an email is sent to the staff member at the user's office who will be contacted or through whom the communication must be scheduled. The email corresponds to step 48 of FIG. 2. The confirming emails enable the user and the staff member to enter the scheduled communication into calendar or schedule programs. It is foreseen that the receipt of the confirming email may cause an automatic entry into the scheduling program of the user and/or the staff member.

If the information in the confirming emails is incorrect, or if there is a need to change the time and date of the contact, an exchange of emails may be carried out to correct or update the information. Thus, through the email communication the user and possibly the user's office administrator, secretary, office manager or other person is made aware of a scheduled communication between the doctor and a vendor of medical devices.

It is envisioned that scheduling or calendaring programs may be used to set up the communication by transmitting communications that request verification of entries directly and automatically into the calendars of the parties rather than requiring manual entry by the parties. Other communications means may be provided as well.

If the user and the vendor's representative are available and willing, a chat or other one-on-one communication is set up immediately between the user and the vendor when the user activates the button requesting a chat session.

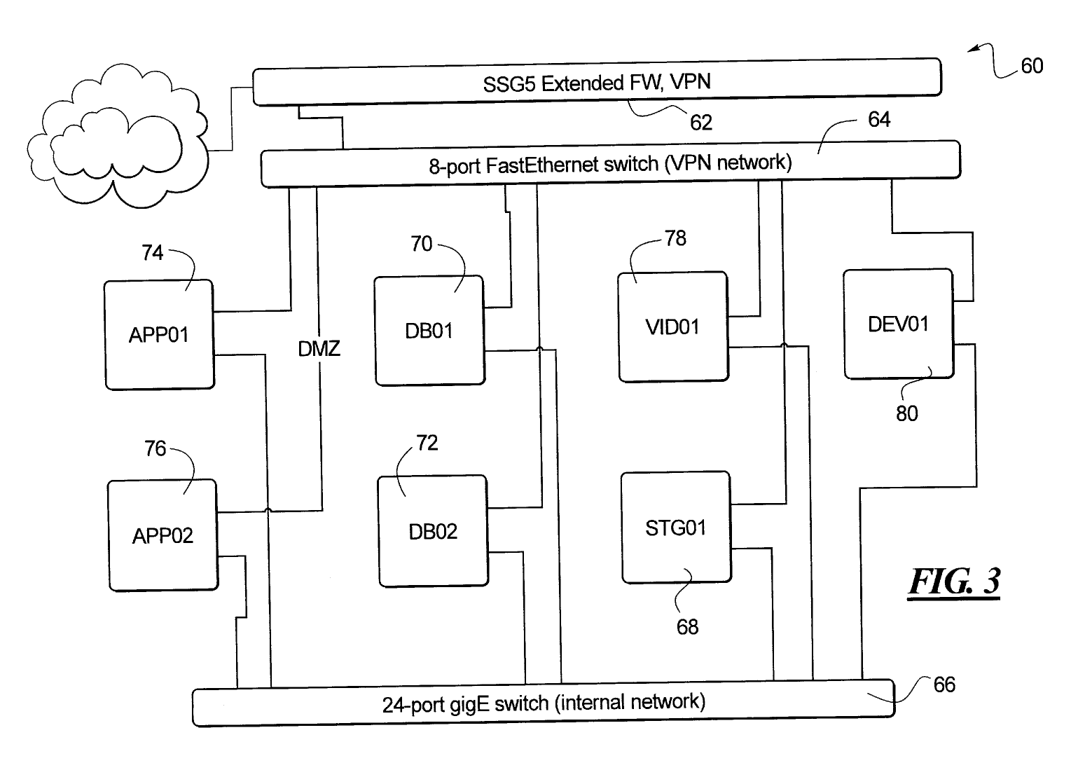

FIG. 3 shows an overview of the network infrastructure 60 used in a preferred embodiment of the present invention. The network is redundant, secure, and provided with encryption of sensitive data, such as patient identification data, so that compliance with patient confidentiality laws, such as HIPAA, is possible. In addition, the provider of any information uploaded to the site and stored on the network is required to verify that a patient permission has been obtained for the information.

In further detail, a firewall 62 that is an HA-capable (clusterable) appliance is provided. Clustering is envisioned for embodiments of the present system. A fast-ethernet switch 64 is connected to one port of the firewall to provide ports for server population expansion. All externally-facing server network interfaces are connected to the switch 64. A gigabit-capable internal switch 66 provides fast, low-latency connectivity between application, database, video processing, and storage services.

Hardware specifications for an exemplary embodiment include the following. The firewall 62 is a Juniper SSG 5 Extended dedicated firewall with site-to-client VPN and site-to-site VPN. A firewall expansion switch 64 provides 12-port dedicated fast-ethernet switching. For the private network switch 66, a 24-port dedicated GigE switch is provided. The storage server 68 is a Premium 7.3: 1× Xeon Quad-Core 5420 2.5 GHz; 8 GB DDR2 RAM; 6×300 10 k RPM SAS Drives, Hardware RAID 5. The database servers 70 and 72 are Intel Dual Core Series Dedicated Server: 1× Intel Core2Quad E6600 CPU; 8 GB DDR2 RAM; 2×250 GB SATA HD, Hardware RAID 1. Application servers 74 and 76 are Intel Quad Core Series Dedicated Server: 1× Intel Core2Duo Q6300 CPU; 8 GB DDR2 RAM; 2×250 GB SATA HD, Hardware RAID1. A separate video server 78 is provided, which is an Intel Quad Core Series Dedicated Server: 1× Intel Core2Quad Q6600 CPU; 4 GB DDR2 RAM; 2×250 GB SATA HD, Hardware RAID1. The dev server or developer server 80 for the system in the example is an Intel Quad Core Series Dedicated Server: 1× Intel Core2Quad Q6600 CPU; 8 GB DDR2 RAM; 2×250 GB SATA HD, Hardware RAID1.

Server provisioning details are as follows, APP01 74 and APP02 76 for Web services and load balancing. Three available external network addresses for NIC eth0 and an interface connected to firewall port, 100 mb/s, full duplex if possible. Three available internal network addresses for NIC eth1 and an interface connected to internal network switch, 1 gb/s, full duplex. Red Hat Enterprise Linux 5.3 installed, 64-bit, minimal software load, no control panel, SSH available. Customer will complete final provisioning. Partitions must be LVM based, except /boot. Unused free space unassigned in volume group. Partitioning based on Partitioning Model “APP” below.

For the database cluster DB01 70 and DB02 72 (MySQL database cluster), one available external network address for NIC eth0 (for VPN use). Interface connected to firewall expansion switch at 100 mb/s speed, full duplex. One available internal network address for NIC eth1. Interface connected to internal network switch at 1 gb/s speed, full duplex. Red Hat Enterprise Linux 5.3 installed, 64-bit. Minimal software load, no control panel, SSH available. Customer will complete final provisioning. Partitions must be LVM based, except /boot. Unused free space unassigned in volume group. Partitioning based on Partitioning Model “DB” below.

The video server VID01 78 (video transcoding server) includes one available external network address for NIC 1 (for VPN use). Interface connected to firewall expansion switch at 100 mb/s speed. One available internal network address for NIC 2. Interface connected to internal network switch at 1 gb/s, full duplex. Windows 2003 Server 32-bit installed. Antivirus product installed. Customer will complete final provisioning.

The storage component is as follows, STG01 68 (storage services) includes one available external network address for NIC eth0 (for VPN use). Interface eth0 connected to firewall expansion switch at 100 mb/s, full duplex. One available internal network address for NIC eth1. Interface eth1 connected to internal network switch at 1 gb/s, full duplex. Red Hat Enterprise Linux 5.3 installed, 64-bit. Minimal software load, no control panel, SSH available. Customer will complete final provisioning. Partitions must be LVM based, except /boot. Unused free space unassigned in volume group. Partitioning based on Partitioning Model “STG” below.

The dev server is as follows, DEV01 80 includes one available external network address for NIC eth0 (for VPN use). Interface eth0 connected to firewall expansion switch at 100 mb/s, full duplex. One available internal network address for NIC eth1. Interface eth1 connected to internal network switch at 1 gb/s, full duplex. Red Hat Enterprise Linux 5.3 installed, 64-bit. Minimal software load, no control panel, SSH available. Customer will complete final provisioning. Partitions must be LVM based, except /boot. Unused free space unassigned in volume group. Partitioning based on Partitioning Model “DEV” below.

Additional address availability is provided by two available internal addresses for use as a virtual address on the DB01/DB02 cluster 70 and 72 and two available external addresses for use as a virtual address on the APP01/APP02 cluster 74 and 76.

Routing and firewall restrictions ensure that HTTP/HTTPS access will be allowed inbound to virtual address for APP01/APP02 cluster 74 and 76. APP01 and APP02 external addresses must be able to communicate with each other. For example, APP01 74 must be able to establish HTTP/HTTPS sessions with APP02 76, and vice versa. APP01 and APP02 74 and 76 must be able to multicast to each other, to support VRRP. Outbound access for FTP, SSH, SMTP, DNS, NTP, HTTP/HTTPS will be allowed from all hosts. Inbound access to all hosts will be prohibited, except as above, except via client-to-site VPN. Additional application firewalling (e.g., ip-tables) will be installed as necessary to augment internal security.

VPN (client-to-site) access may include the following access control groups as desired: DEV-SSH, HTTP/HTTPS access to DEV01 80; DBA-SSH, HTTP/HTTPS access to DB01 and DB02 70 and 72; and OPS-SSH, HTTP/HTTPS access to all hosts.

In one example, a 10-user license will be provided. VPN (site-to-site) access configuration of remote end point for VPN tunnel can be provided. Backups are be focused on the STG01 server 68. A preferred backup strategy is a grandfather-father-son rotation with daily incremental, weekly differential, and monthly full backups of all file systems on the server to secure storage.

The partition model APP provides that the /boot is non-LVM. All remaining disk space will be assigned to LVM volume group, all remaining file systems allocated from this volume group. Unallocated space in VG is to be left unassigned and available to customer. A /boot of 100 MB, ext3, non-LVM, a swap of 4 GB, LVM, and a/(root) of 30 GB, LVM. For the database server, a partition Model DB provides that the /boot is non-LVM. All remaining disk space will be assigned to LVM volume group, all remaining file systems allocated from this volume group. Unallocated space in VG is to be left unassigned and available to customer. A /boot of 100 MB, ext3, non-LVM, a swap of 4 GB, LVM, and a /(root) of 30 GB, LVM is provided. The partition Model STG provides that the /boot is non-LVM. All remaining disk space will be assigned to LVM volume group, all remaining file systems allocated from this volume group. Unallocated space in VG is to be left unassigned and available to customer. A /boot of 100 MB, ext3, non-LVM, a swap of 4 GB, LVM, and a /(root) of 30 GB, LVM is provided.

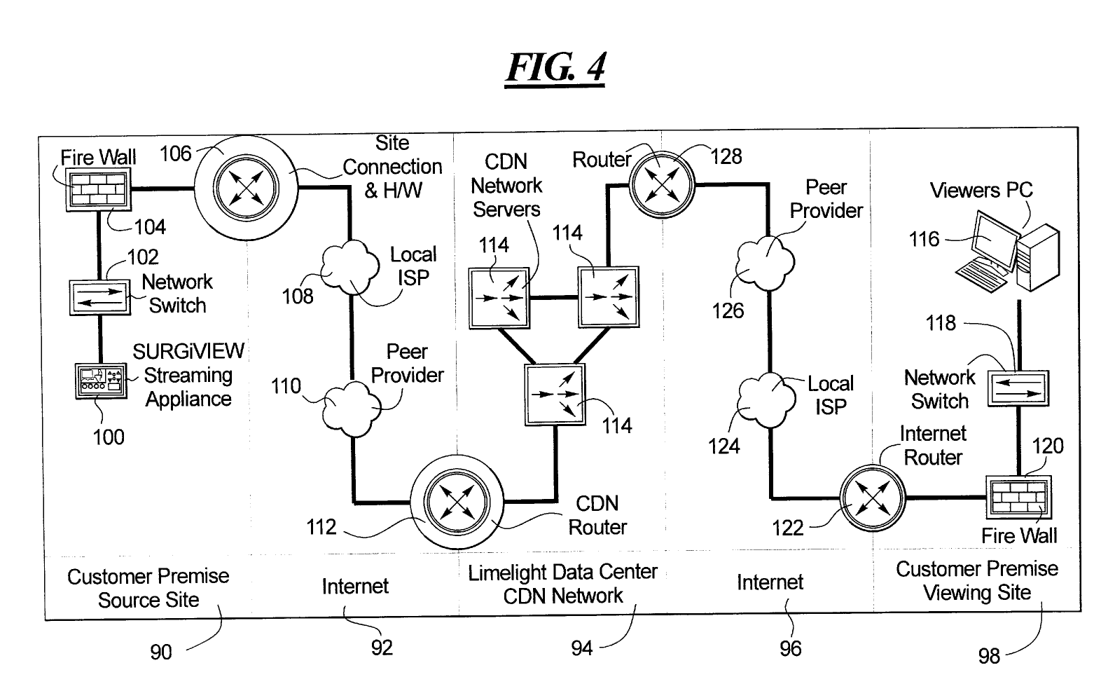

FIG. 4 is a network communication diagram that shows a customer premise source site 90, an Internet communication component 92, a data center CDN network component 94, another Internet communication component 96, and a customer premise viewing site 98. The source site 90 includes a computer or other computer readable media on which is stored a video of a surgical procedure. The video is preferably in digital video format, although it may have been shot in analog format and converted to a digital format. The video data may have been prepared for training purposes or may be been obtained in the course of a procedure by a doctor, as many procedures are captured on video, particularly those involving laparoscopy or other minimally invasive procedures that often include machine assisted visualization. Still images and other related data may also be available at the source 90. The source video data is tagged to identify the procedure, the tools used in the procedure and possibly other information relevant to viewers. Patient identification information is omitted or if present is encrypted or otherwise obscured.

The video data is uploaded from the computer by a streaming appliance 100 at the source site 90. The streaming appliance 100 may be a computer or an application or program running on a computer. The video data is passed through a network switch 102 and through a firewall 104 to site connection hardware 106, such as a router. The router 106 sends the video data onto the Internet 92, where the data is handled by a local ISP (Internet Service Provider) 108 and then to a peer provider 110.

The peer provider 110 sends the uploaded video data to a CDN (Content Delivery or Distribution Network) router 112 which receives the video data and forwards it for storage on CDN network servers 114 in the data center 94. The CDN network servers 114 may be configured as shown in FIG. 3, or in some other configuration. The stored video data is maintained on tangible computer readable media in the data center 94 along with other video data and the programs and information necessary to the present system and method.

A user, such as a surgeon, seeks information on new surgical techniques. The surgeon may have learned of the new technique though outside sources, such as journals or word of mouth, or may have learned of the new technique via the information and communications provided at the web site provided by the present invention. The user is as a viewers PC or other computer or computer device 116 at the customer premise viewing site 98. The user's computer 116 has a display on which a user interface such as the user interface of FIG. 1 may be shown. The computer 116 of the example also includes a housing containing a microprocessor and associated circuitry along with a computer readable storage media such as a hard drive, as well as a user interface such as a keyboard and mouse. Other configurations and types of computers are of course possible. The viewing site may be the user's office, user's home or other location. In the present example, the user is at an office or home site with a network, although this need not be the case in every instance.

The user is at the computer and viewing the web site where the user enters a request for a video of a particular surgical procedure via the viewer computer 116. The request is sent via a network switch 118 and through a firewall 120 to an Internet router 122. The Internet router 122 connects to the viewing site 98 to the Internet, as indicated at 96 in FIG. 4. The router 122 connects to a local ISP 124 and through a peer provider 126 to a router 128 of the data center 94. The data center servers 114 read the requested video data from the storage media and transmit the video data back through the router 128 and through to the Internet channels 126 and 124 to the router 122, through the firewall 120 and network switch 120 to the viewer's computer 116. The user watches the video as streaming data from the data center 94 and sees the information on the tools used in the procedure displayed on the interface.

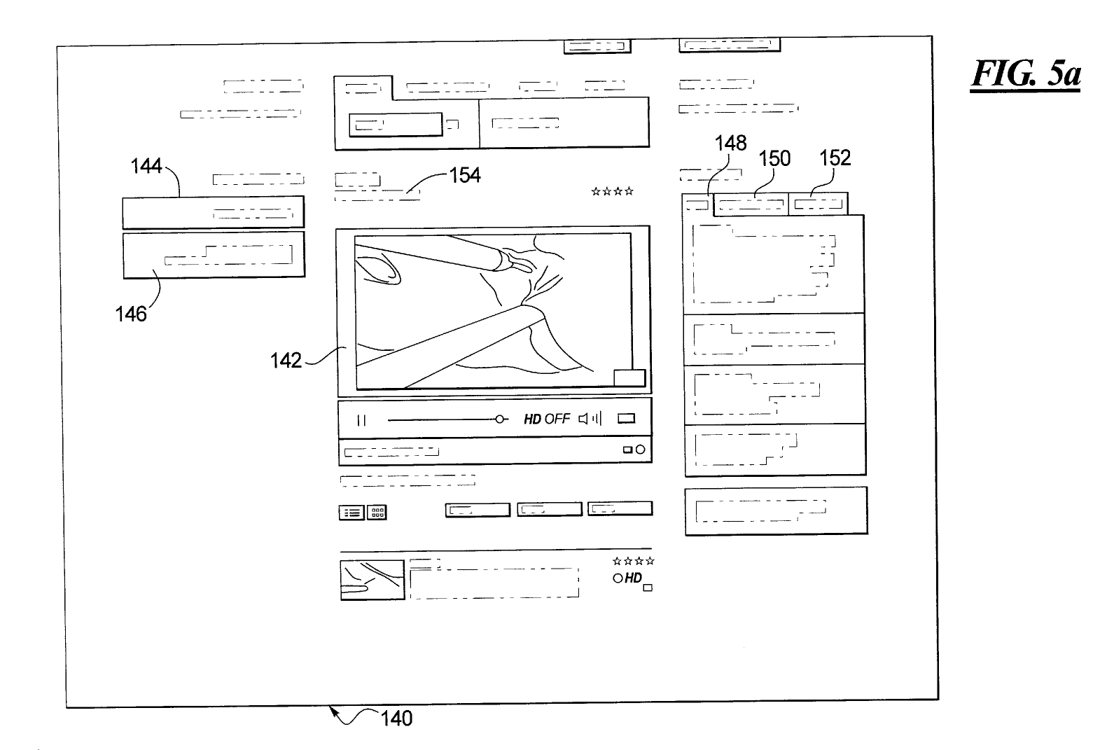

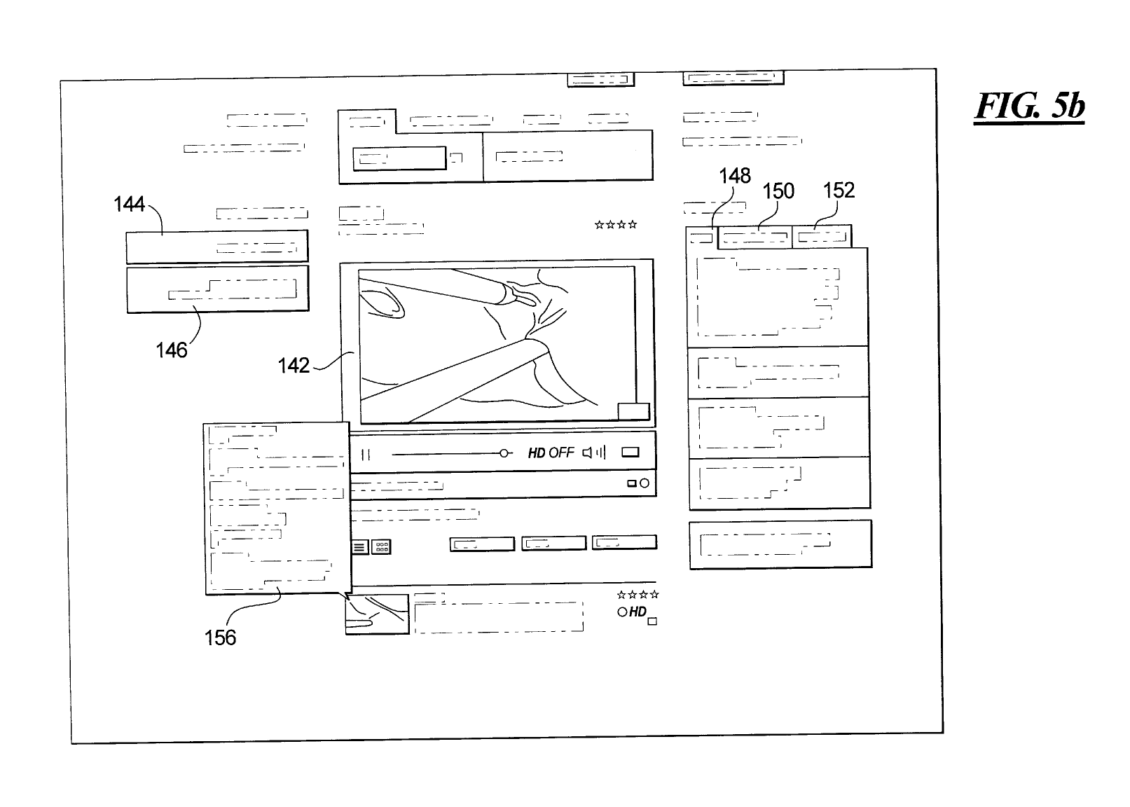

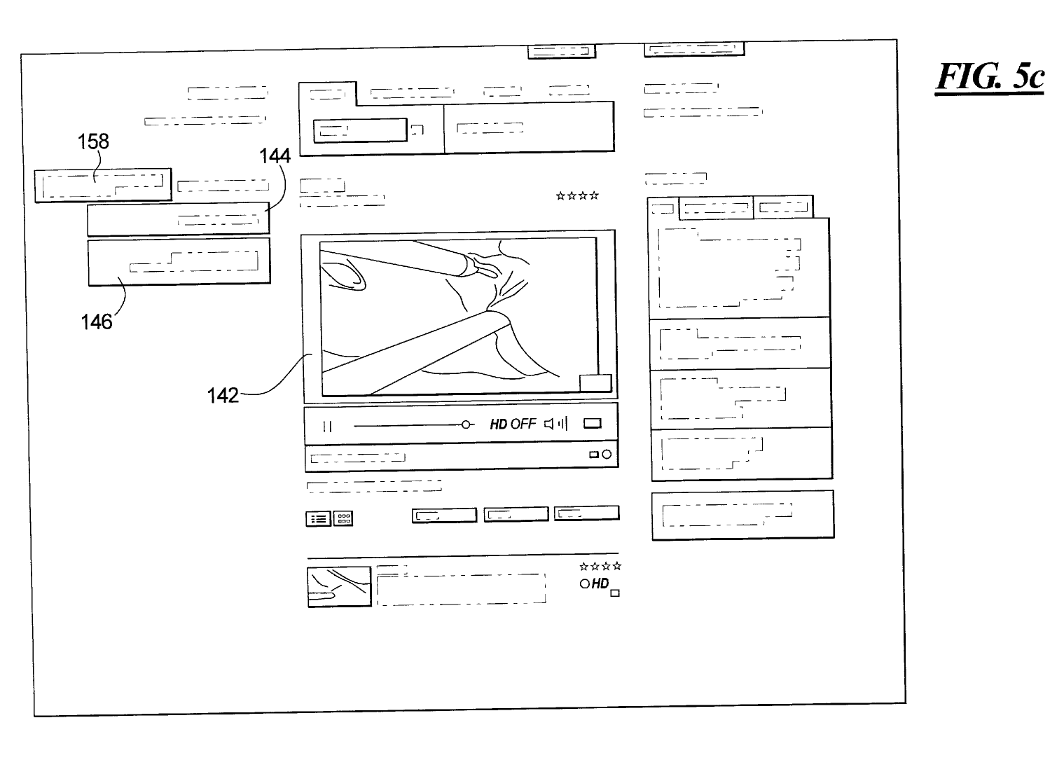

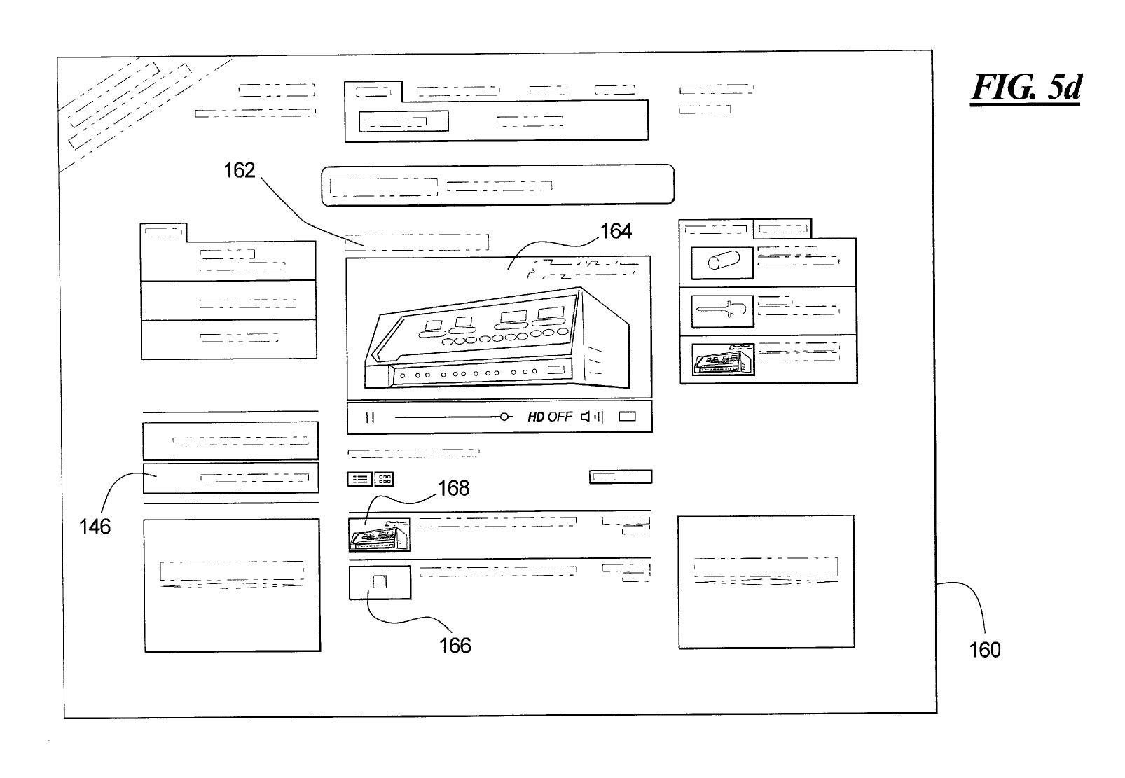

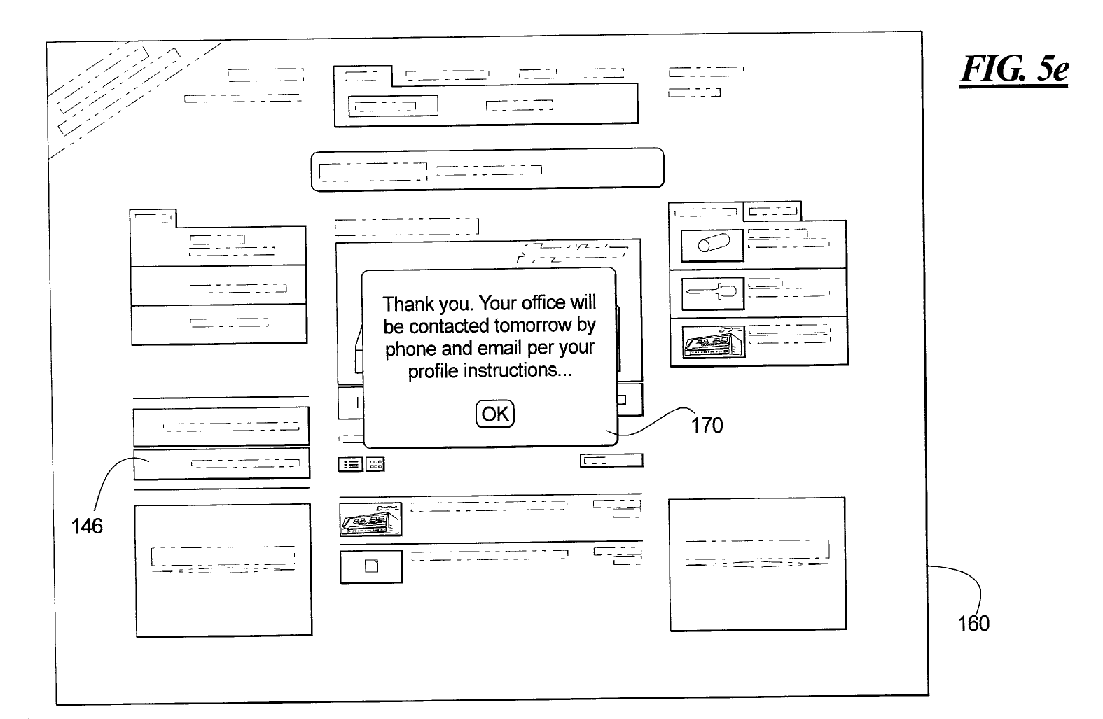

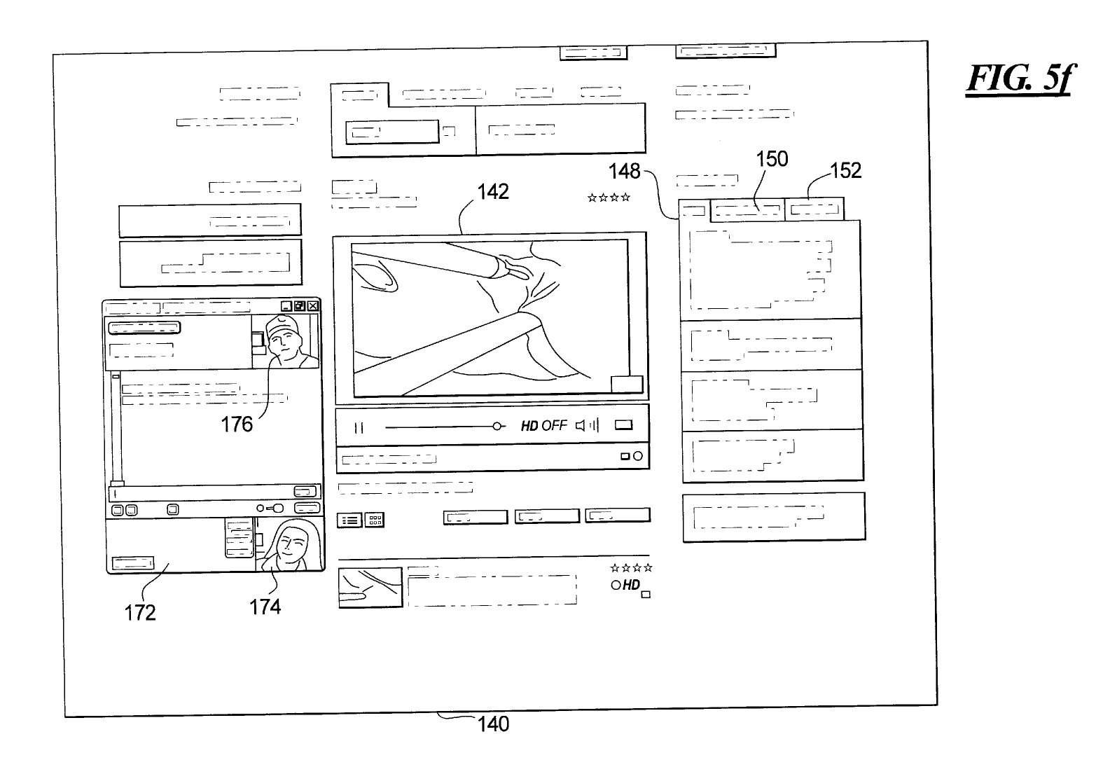

FIGS. 5a-5f show another example of the user interface. In FIG. 5a, the user has searched the site 140 for information, here LSH-1, and is provided with a video of an LSH-1 procedure on a video display portion 142. A products in use list 144 to the left identifies the tool in use in the video and below that is a request 146 to speak to a vendor of the tool. To the right is a discussion section 148 in which comments are shown as posts by others who have viewed the video. Tabs for a video conference 150 and how to use information 152 are also provided. The doctor performing the procedure is also listed at 154.

FIG. 5b shows a pop up 156 that appears when the user moves the mouse pointer over the video 142. The pop up 156 gives information on the video including running time, procedure, diagnosis, instruments used, number of incisions, and key words.

In FIG. 5c, a pop up 158 appears at the button 144 identifying the tool indicating that the user may select the button 144 for more information on the product.

With reference to FIG. 5d, the user has selected the button 144 indicated in FIG. 5c and is redirected to a page 160 containing information on the tool in use in the video. The product information screen 160 identifies the product 162, includes a video 164 of the product and provides links to manuals 166, demonstrations 168 and other information that the user may need to make a decision on obtaining this product for the user's practice.

On many if not all of the screens is provided a button 146 requesting contact with the vendor. In FIG. 5e, the request button 146 has been activated. This sends the emails or other contact requests to the vendor and confirmations to the user and possibly to the user's staff. A dialog box 170 appears thanking the user and indicating that the user will be contacted according to the profile instructions. In this case, the user has filed out a profile in advance indicating preferred contact information, including a telephone number, contact person, and possibly contact times. The contact information may be filled out in advance or at the time of the request.

In FIG. 5f, the user is returned to the screen 140 displaying the video 142 of the procedure and has selected the tab 150 to the right requesting a video conference. A pop up 172 appears in which a video chat conference between the user 174 and the doctor 176 who performed the procedure appears so that the user may ask questions and learn further information on the procedure.

The system and method is a synthesis of commerce, community, content-appreciation and collaboration in a single online web destination, for connecting industry and professional, academic and public users of the same broader community together for enhancing global personal and professional relationships and for the sharing of up-to-date information, messages, video chat and content, including details of industry vendor offerings which expressly serve the professional user based and other user groups involved.

Through a web interface, the technology provides the virtual bridge to easily connect various user groups to each other and to content and products/services that are generated or offered by different users and groups within the overall community, while taking advantage of the global reach and time-independency of the Internet.

Utilizing data and programs via web technology and interface design, the method and system provides connectivity through easy, least-click effort and contextual-based user choices (for example, by mouse clicks on hyperlinks directly tethered to user searches and content viewings), facilitating moment-to-moment connectivity between users and between their offerings/content. The system and method facilitates enhanced relationships between community groups and members as well as provides accelerated access for its various users to the content, information and business offerings (products and services) that the industry vendor group provides to the other users that define the community through their variety of various group types (professional, academic, public, etc.).

The system's design for connectivity, interactivity, collaboration; the permission-based access to features and functionality (for example, based on group affiliation), and the self-driven user engagement aspect creates an opportunity for both individual user development (for example, practitioner growth) and the development of the community itself for matters economic, education, ability, membership value and otherwise.

The system and method includes:

A. Public Archive

The invention involves a web technology platform that contains a public archive, using the storage of the servers at the data center, of rich media content that all users can search and view the content thereof. Specified users (for example, professional users) can upload content to this archive through the web. The uploading user (who may be referred to as the content owner or content generator) must input details about the content (metadata tagging). Some tag values may be required.

The tagged content creates a direct bridge for the vendors, service providers and/or manufacturers to their target market (professional users, academic audience, or public users) whose products and service play a role in the activity or meaning of viewed content which the users seek and digest.

Thus, the system and method allows for a user to view a video, image, audio, document, file of a community related matter, process or event (for example, a documented creative act, a surgical video, a training film conveying essential safety devices) and the industry vendor tools, devices or services that support or helped create that content are listed clearly next to the video or otherwise associated with the information.

The user is now informed regarding how the content connects to their interests and the community both professionally, creatively or for educational and training purposes.

How the user acts on this knowledge (for example, what product was used in the formation of the viewed video content) toward reaching out to peers, colleagues, the industry vendors toward bettering their own professional or personal self or abilities and toward improving the growth of the community as a whole (both professionally and economically) is part of the purpose of the offering and is discussed in points below.

B. Private Archives

1. Individual members of distinct user groups in the community can possess private archives within the system. The private archive has access to its own tagged, searchable and viewable content.

2. Organizations or entities (such as academic institutions or private companies) can also possess ownership of a private archive as a means of housing and delivering content, messaging, information to its user base. Access to this private archive is controlled by the owning institution or company. Views of uploaded private archive content can be audited and this data shared with the private archive owner to communicate what members of their private access-granted community has viewed which assets.

a. An Example: Academics

For the academic group, access is controlled and content is uploaded by the group's parent body/bodies, such as a university, to serve their constituent base/audience. Within the system, the academic user can appreciate content specifically populated in the main public archive by the parent group (e.g., the University) which enhances their potential to develop as professionals in the arena they are presently being schooled in. The private archive provides access to search and view research university-specified content designated for their critical consumption, per curricula requirements or otherwise.

C. Industry Connection to the Other User Groups and the Industry Corner

The system and method of the invention, above all, offers seamless connectivity from industry vendors to the professional and non-professional user groups that utilize their products and services. All content could be tagged with a variety of metadata field values, including a product name associated with the content (e.g., a surgical implement used in a surgical procedure video).

This tagging thus allows for the viewing and/or searching user to be presented with the product name(s) associated with the content presently being viewed; the web offering presents these metadata tags (the product names) with hyperlinks or other user operable controls.

The product name hyperlinks, when clicked, drive the user to the industry corner portion of the web sited, which presents a private archive of search results populated with rich media content (including marketing videos, whitepapers, images of vendor products) that the user can sort through and view.

Furthermore, the industry corner also presents the following on the same page:

1. MESSAGES: which are clickable links that drive the user to URL or RSS news feeds that the vendor has defined (i.e., “UPCOMING EVENT: November Regional Medical Conference” or “Vendor Company Acquisition” on-line PDF file).

2. PRODUCTS: which showcases a set or single entry of vendor products complete with images and product names or details. These items are all also connected to URL addresses and are therefore hyperlinks. Clicking on such links also drives the user to a web destination of the vendor's designation (c.f., the vendor's product page on their company website for the product explicated here).

3. HOT NEW PRODUCTS: which showcases a set or single entry of newly released vendor products, complete with images and text that are hyperlinks which when clicked drive the user to a URL destination designated by the vendor previously.

4. Clickable banner advertisements: which drive the user to web destinations designated by the URL in the banner ad by the vendor.

5. HAVE VENDOR CONTACT ME: This function allows the user to request contact from the vendor in a single click. Upon clicking a “Have Vendor Contact Me” button, the system sends precise information that was captured in the original user account profile. The transmitted information includes information on how the user desires to be contacted, such as by email, by telephone or via standard mail. The transmitted information also includes a request that a member of the user's company that the vendor should contact (if desired). In addition, the information may include an email address where the user can be reached, and/or a phone number where the user can be reached, as well as a time of day when the vendor may contact that user.

The user is presented with a dialogue box after clicking the “Have Vendor Contact Me” button indicating that the request for contact has been sent to the vendor.

6. OTHER TEXT DESCRIPTORS: that connect a subject/construct meaningful to the community to the various user groups.

7. The designated vendor administrative user has the ability to add, remove, or modify assets and the metadata of assets that they upload in the system, including the text, images and URL or RSS details at their own convenience over the Internet.

D. Instant Easy Connectivity—Video, Chat and Email

1. VIDEO/AUDIO CHAT can be initiated by the user to connect instantly with the owner/content generator of a particular asset that the user is viewing at the moment; a contextual link offers one-click access to reach out to that content owner/generator.

2. TEXT CHAT can be initiated by the user to connect instantly with the owner/content generator of a particular asset the user is viewing at the moment; a contextual link offers one-click access to reach out to that content owner/generator.

3. EMAIL can be initiated by the user to connect with the owner/content generator of a particular asset that the user is viewing at the moment; a contextual link offers one-click access to reach out to that content owner/generator to send them an email instantly.

4. VIDEO CHAT and/or TEXT CHAT can also be executed at any point to a public room, a virtual space, where users can video and text chat with other members of the community that are on line; any user can click on another on-line user and request a private chat immediately to hold private video, audio and text discussion with this user away from the public room.

5. A “SPEAK WITH VENDOR” link also provides direct and easy opportunity for the user to contact a particular vendor user via video/audio chat or email.

E. Discussions and Forums

As another means of connecting the community together for relationship building and idea sharing, discussions exist in the form of topics, replies and threads that are posted by users. A forum is also offered to the community, presenting the discussion topics connected to an asset as well as an open arena of other topics which can be defined by an individual user for sharing ideas, posing questions and responding to fellow community member's perspectives.

1. Discussions surrounding content which includes the instruments, products, or devices essential to the content's production as well as that the content is tagged by live next to the media player. All users, segregated by group type, can join the discussion, contribute new topics, reply to existing topics and engage in a community self-policing of inappropriate content. This communication is intended in part to prepare the professional users or grow the community to server their client base or provide better patient care, especially in communities where best or latest technology or tools used are divisive for providing best care or services and thus tight connectivity between the user and vendor is helpful.

2. Users can engage in discussion surrounding any asset in the system. This occurs on the same page as they view an asset. The DISCUSSION threads are viewable next to the asset. Access to add/flag for inappropriateness/update/reply to discussions topics or threads is readily available in the UI (user interface) as well.

3. A user may reach out and connect with a particular poster user (one who posted a discussion topic) directly with one click, by clicking on a button offering the user a connection to a video or text chat with the posting user. This brings the user to a video chat or text chat window to engage with the posting user. The user can also click to connect with the poster user via email.

4. Users can view discussions of various user groups and some user group users (such as the professional user) can participate in discussions with other user group users. The privileges of one group to participate or view discussions of other groups is dynamic and configurable.

F. Media Services

Because the value of the invention is directly proportional to the value of the archive, the present method and system also offers media services to assist the community members in transporting their content into the system.

Representatives for the web site can provide tips and training on how to upload content and tag it for the system.

Moreover, the web site also provides media services in the two following forms to easier facilitate transport of community content into the system:

1. A user can request that their raw video content be packaged (e.g., multiple files relating to a single piece of content can be edited together) and digitally post-produced (edited) to enhance the presentation value of the content with editing, narration and other creative services.

2. A user can request that a representative of the web site administration organization visit their physical site (e.g., office) and personally capture required tagging information, migrate the content digital files to the system (data copy and upload effort) and tag the content.

G. User content can also be sold within the system via e-commerce functionality; this will provide access to the content to users seeking viewing off the Internet.

H. Reviews/Collaboration

Within the web site, users can optionally upload COLLABORATION or REVIEW videos where the user makes suggestions regarding industry vendor products. The industry vendor in this area has the ability to offer their own rebuttal video to address the COLLABORATION video. One reason behind this feature is to foster a tighter relationship between the professional and product user aspect of the community with the vendors of the community, with part of its intent to facilitate better product development and design based on product user testimony, criticism and suggestion.

The present invention provides a single location for surgeons worldwide to share experiences, learn from one another and enhance patient care. Vendors are available at any time. Vendors may expand their reach to targeted professionals and enhance educational opportunities through the web site. Not only training for professionals but trouble shooting for vendors is provided, along with the ability to train vendor sales force personnel in the needs of the professionals.

Users may archive information, including video information, at a secure site that is compliant with HIPAA rules. Picture archiving is also provided. Instant communications between professionals is available at the web site using text messaging, email, video chat, message boards, and the like. Surgeons, academics and industry personnel may use the site.

Thus, the present web site provides the ability for a surgeon with limited time the chance for continuing education and training, keeping current with new techniques. Vendors have an access point to offer products to the surgeons and can more easily capture the attention of the surgeon. Rural practitioners and those outside of major metropolitan areas are provided with current information and products. Geographic barriers are broken down. Relationships are created and fostered by the interactive community available on the web site. Links to additional sites and information is possible on the site.

Thus, there is a provided a communication channel, as a web site in one embodiment, that teaches techniques to professionals and that provides information on the tools used in the techniques and the further sets up communications between the user and vendor of the tools.

Although other modifications and changes may be suggested by those skilled in the art, it is the intention of the inventors to embody within the patent warranted hereon all changes and modifications as reasonably and properly come within the scope of their contribution to the art.

We claim:

1. A method of linking vendors of a product to users of the product, comprising the steps of:
displaying a video of a procedure on a display of a user computer;
displaying on the display of the user computer identifying information of a tool used in the video;
displaying a link to the vendor of the tool on the display of the user computer; and
automatically scheduling a one-on-one communication between a user of the computer and a vendor of the tool upon activating of the link.

2. A method as claimed in claim 1, wherein said step of displaying a video displays a video of a surgical procedure; wherein said step of displaying information of a tool displays information of a surgical tool used in the video; and wherein said step of automatically scheduling includes scheduling a one-on-one communication between a surgeon and a vendor of the surgical tool.

3. A method as claimed in claim 1, wherein said step of automatically scheduling a one-on-one communication includes sending schedule information to the user's computer and to the vendor's computer.

4. A method as claimed in claim 3, wherein said step of automatically scheduling includes sending schedule information to a computer of an office manager or staff member of the user.

5. A system for linking vendors of a product to users of the product, comprising:
a user computer having a microprocessor and a display and a user input and tangible computer readable media, said user computer being programmed to display user interface information received over a network connection, said user computer being programmed to display video data of a procedure and to display information on tools used in the video, said user computer being operable to transmit a request by a user for a one-on-one communication between the user and a vendor of a tool used in the video; and
a network connection to said user computer, said network connection being operable to provide user interface data and video data to the user computer, said network connection being operable to provide information on a tool used in the video to the user computer, said network connection being operable to transmit request information for one-on-one communications from the user computer.

6. A system as claimed in claim 5, wherein said video data shows a surgical procedure and wherein said tool is a surgical tool.

7. A system for linking vendors to users, comprising:
a server computer having a microprocessor and tangible computer readable media on which is stored video data of a procedure using a tool,
a link between said video data and data regarding the tool used in the video, said link being stored on the computer readable media;
a link between a vendor of the tool and at least one of the video data and data regarding the tool;
a network connection to said server operable to carry the video data from the server to a network and operable to transmit to the server a request for linked data regarding the tool used in the video and operable to transmit to the server a request for linked vendor information;
a program to schedule a one-on-one communication between the user and the vendor of the tool.

8. A method of linking vendors of a product to users of the product, comprising the steps of:
displaying educational or training information to a user on a display of a user computer, the educational or training information including education or training on use of a tool or product;
displaying information on the tool or product on the display of the user computer;
displaying a user operable command on the display of the user computer;
automatically scheduling a telephone communication between a user of the computer and a vendor of the tool or product.
